(19) United States
(12) Patent Application Publication
(10) Pub. No.: US 2025/0260033 A1
(43) Pub. Date: Aug. 14, 2025

(54) FUEL CELL SYSTEM

(71) Applicant: TOYOTA JIDOSHA KABUSHIKI KAISHA, Toyota-shi (JP)

(72) Inventors: Susumu HASHIMOTO, Ebina-shi (JP); Satoshi Andoh, Fuji-shi (JP); Ryuhei Kataoka, Nisshin-shi (JP); Dai Horiguchi, Shizuoka-ken (JP)

(73) Assignee: TOYOTA JIDOSHA KABUSHIKI KAISHA, Toyota-shi (JP)

(21) Appl. No.: 18/955,064

(22) Filed: Nov. 21, 2024

(30) Foreign Application Priority Data
Feb. 13, 2024 (JP) 2024-019613

(51) Int. Cl. H01M 8/04746; H01M 8/04701

(52) U.S. Cl. CPC H01M 8/04753; H01M 8/04723; H01M 8/04776

(57) ABSTRACT

A fuel cell system includes: a plurality of fuel cell stacks; an oxidizing gas supply unit including a turbo compressor that supplies an oxidizing gas to each of the fuel cell stacks; a cooling unit that cools each of the fuel cell stacks; and a control device that determines, according to the requested output, a requested number of fuel cell stacks to be operated out of the fuel cell stacks, a target supply pressure of the oxidizing gas and a target supply flow rate of the oxidizing gas that are to be sent as a command to the oxidizing gas supply unit, and a target cooling temperature of the fuel cell stacks that is to be sent as a command to the cooling unit. The control device reduces the target cooling temperature when reducing the requested number of fuel cell stacks to be operated.

### CROSS-REFERENCE TO RELATED APPLICATION

This application claims priority to Japanese Patent Application No. 2024-019613 filed on Feb. 13, 2024, incorporated herein by reference in its entirety.

### BACKGROUND

### 1. Technical Field

The technique disclosed in the present specification relates to fuel cell systems.

### 2. Description of Related Art

Japanese Unexamined Patent Application Publication No. 2022-156906 (JP 2022-156906 A) describes a fuel cell system. This fuel cell system includes: a plurality of fuel cell stacks; an oxidizing gas supply unit that supplies an oxidizing gas to each of the fuel cell stacks; a cooling unit that supplies a cooling medium for cooling each of the fuel cell stacks; and a control device that determines a target supply flow rate of the oxidizing gas that is to be sent as a command to the oxidizing gas supply unit and a target supply flow rate of the cooling medium that is to be sent as a command to the cooling unit.

### SUMMARY

In such a fuel cell system, the number of fuel cell stacks to be operated (that is, to generate electric power) may be reduced when the output requested from the outside is relatively low, when a failure occurs in part of the fuel cell stacks, etc. In this case, the requested output is greatly increased in those fuel cell stacks that continue to be operated.

The supply pressure and supply flow rate of the oxidizing gas to be supplied to a fuel cell stack are determined according to the output requested of the fuel cell stack (namely, the electric power to be generated by the fuel cell stack) and the temperature of the fuel cell stack. For example, when the temperature of the fuel cell stack is constant, the supply pressure and supply flow rate of the oxidizing gas need to be increased as the output requested of the fuel cell stack increases. Therefore, when reducing the number of fuel cell stacks to be operated, the supply pressure and supply flow rate of the oxidizing gas need to be increased in those fuel cell stacks that continue to be operated. In this case, if a turbo compressor is used to supply the oxidizing gas, surging may occur due to an increase in pressure ratio in the compressor. One possible way to avoid this is to reduce an increase in supply pressure of the oxidizing gas by preferentially increasing the supply flow rate of the oxidizing gas. However, the lower the supply pressure of the oxidizing gas or the higher the supply flow rate of the oxidizing gas, the more drying of an electrolytic membrane is accelerated in the fuel cell stacks, which may cause so-called drying up of the fuel cell stacks.

In view of the above circumstances, the present specification provides a technique of avoiding drying up of fuel cell stacks while avoiding surging of a turbo compressor.

As described above, when the number of fuel cell stacks to be operated is reduced, the requested power is increased in those fuel cell stacks that continue to be operated. Therefore, the supply pressure and supply flow rate of the oxidizing gas need to be increased accordingly. In this case, an increase in supply pressure of the oxidizing gas can be reduced by preferentially increasing the supply flow rate of the oxidizing gas. This reduces an increase in pressure ratio in the compressor, so that surging of the compressor can be avoided. Moreover, reducing the temperature of the fuel cell stacks reduces an increase in supply pressure of the oxidizing gas. Even when the supply flow rate of the oxidizing gas is increased accordingly, drying up of the fuel cell stacks can be reduced. That is, when reducing the number of fuel cell stacks to be operated, the temperature of those fuel cell stacks that continue to be operated is reduced. This can avoid drying up of the fuel cell stacks while avoiding surging of the turbo compressor.

Based on the above findings, the technique disclosed in the present specification is embodied in a fuel cell system. According to a first aspect, a fuel cell system includes:
a plurality of fuel cell stacks;
an oxidizing gas supply unit including a turbo compressor that supplies an oxidizing gas to each of the fuel cell stacks;
a cooling unit that cools each of the fuel cell stacks; and
a control device that determines, according to the requested output, a requested number of fuel cell stacks to be operated out of the fuel cell stacks, a target supply pressure of the oxidizing gas and a target supply flow rate of the oxidizing gas that are to be sent as a command to the oxidizing gas supply unit, and a target cooling temperature of the fuel cell stacks that is to be sent as a command to the cooling unit.
   The control device reduces the target cooling temperature when reducing the requested number of fuel cell stacks to be operated.

With the above configuration, when reducing the number of fuel cell stacks to be operated, the temperature of those fuel cell stacks that continue to be operated can be reduced. It is therefore possible to avoid drying up of the fuel cell stacks while avoiding surging of the turbo compressor.

According to a second aspect, in the first aspect, after reducing the target cooling temperature according to a reduction in the requested number of fuel cell stacks to be operated, the control device may reduce an actual number of fuel cell stacks to be operated after an actual temperature of the fuel cell stacks decreases to a predetermined value. Such a configuration can more reliably avoid drying up of the fuel cell stacks even in a case there is a time lag between when the target cooling temperature is reduced and when the actual temperature of the fuel cell stacks decreases to the predetermined value.

As described above, reducing the number of fuel cell stacks to be operated may cause surging of the turbo compressor. In order to avoid this, it is effective to reduce an increase in pressure ratio in the compressor by preferentially increasing the supply flow rate of the oxidizing gas for those fuel cell stacks that continue to be operated. However, reducing an increase in supply pressure of the oxidizing gas and increasing the supply flow rate of the oxidizing gas accordingly may cause drying up of the fuel cell stacks. Drying up of a fuel cell stack depends on the temperature of the fuel cell stack. The higher the temperature of the fuel cell stack, the more drying up of the fuel cell stack tends to occur.

It is therefore effective to prohibit or limit a decrease in number of fuel cell stacks to be operated when the temperature of the fuel cell stacks is high. Specifically, regardless of the temperature of the fuel cell stacks, the number of fuel cell stacks to be operated is reduced when the overall output requested of the fuel cell system is lower than a predetermined reference value. This reference value is not a fixed value. The higher the temperature of the fuel cell stacks, the lower the reference value is set. This reduces an increase in requested output in those fuel cell stacks that continue to be operated, and reduces an increase in supply pressure and supply flow rate required for these fuel cell stacks. It is therefore possible to avoid drying up of the fuel cell stacks while avoiding surging of the turbo compressor.

Based on the above findings, the technique disclosed in the present specification is embodied in another fuel cell system. That is, according to a third aspect, this fuel cell system includes:
a plurality of fuel cell stacks;
an oxidizing gas supply unit including a turbo compressor that supplies an oxidizing gas to each of the fuel cell stacks;
a cooling unit that cools each of the fuel cell stacks; and a control device that determines, according to the requested output, a requested number of fuel cell stacks to be operated out of the fuel cell stacks, a target supply pressure of the oxidizing gas and a target supply flow rate of the oxidizing gas that are to be sent as a command to the oxidizing gas supply unit, and a target cooling temperature of the fuel cell stacks that is to be sent as a command to the cooling unit.
   The control device decreases the requested number of fuel cell stacks to be operated when the requested output is lower than a predetermined reference value, and sets the reference value to a lower value as an actual temperature of the fuel cell stacks increases.

With the above configuration, when reducing the number of fuel cell stacks to be operated, the higher the temperature of the fuel cell stacks, the more an increase in output requested of those fuel cell stacks that continue to be operated is reduced. That is, an increase in supply pressure and supply flow rate of the oxidizing gas that are required of the fuel cell stacks is also reduced. It is therefore possible to avoid drying up of the fuel cell stacks while avoiding surging of the turbo compressor.

According to a fourth aspect, in the third aspect, when the actual temperature of the fuel cell stacks is higher than a predetermined upper limit temperature, the control device may not reduce the requested number of fuel cell stacks to be operated, regardless of the requested output. Such a configuration can avoid a situation in which the temperature of those fuel cell stacks that continue to be operated increases excessively.

According to a fifth aspect, in the third or fourth aspect, when the actual temperature of the fuel cell stacks is lower than a predetermined lower limit temperature, the control device may not reduce the requested number of fuel cell stacks to be operated, regardless of the requested output. Such a configuration can avoid a situation in which the temperature of those fuel cell stacks that are stopped decreases excessively.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a fuel cell system according to a first embodiment;

FIG. 2 is a diagram illustrating a relationship between a target supply pressure and target supply flow rate of an oxidizing gas;

FIG. 3 shows a surging constraint line of a compressor;

FIG. 4 is a flowchart illustrating a first process executed by the control device;

FIG. 5 shows changes over time of various parameters in the first process shown in FIG. 4;

FIG. 6 shows a map showing the regions in which the control device permits independent operation and the regions instructing operation in the two fuel cell stacks according to the output required for the fuel cell system;

FIG. 7 is a flowchart illustrating a second process executed by the control device;

FIG. 8 shows changes over time of various parameters in the second process shown in FIG. 7; and

FIG. 9 is a diagram schematically illustrating a configuration of a fuel cell system according to a second embodiment;

### DETAILED DESCRIPTION OF EMBODIMENTS

### Example 1

The fuel cell system 10 of the present embodiment will be described with reference to the drawings. The fuel cell system 10 is a power generation system that is mounted on a moving object (for example, an automobile, a bus, a truck, a train, a ship, an airplane), a stationary fuel cell device, or the like, and outputs electric power in response to an output requested from the outside.

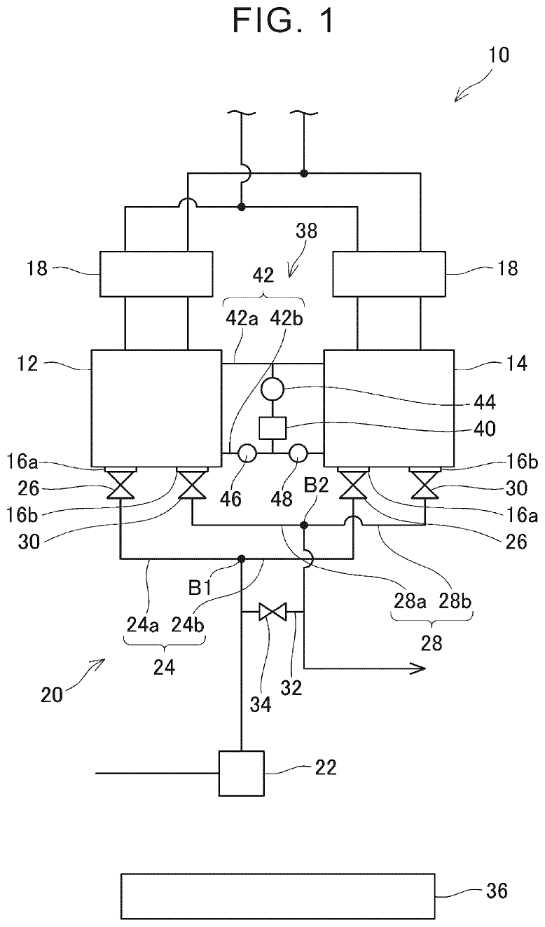

As shown in FIG. 1, the fuel cell system 10 includes a plurality of fuel cell stacks 12 and 14. Each of the fuel cell stacks 12 and 14 has a structure in which a plurality of fuel cell cells are stacked. The fuel cell stacks 12 and 14 include an anode-side supply port (not shown), a cathode-side supply port 16a, an anode-side discharge port (not shown), and a cathode-side discharge port 16b. The anode-side supply port and the cathode-side supply port 16a of the fuel cell stacks 12 and 14 are connected to each of the plurality of fuel cell cells in the fuel cell stacks 12 and 14. The fuel cell stacks 12 and 14 generate electric power by chemically reacting the fuel gas taken in from the anode-side supply port and the oxidizing gas taken in from the cathode-side supply port 16a in the plurality of fuel cell cells. Gases (i.e., off-gas) that have passed through the plurality of fuel cell stacks 12 and 14 are discharged to the outside from the anode-side discharge port and the cathode-side discharge port 16b.

The plurality of fuel cell stacks 12, 14 includes a first fuel cell stack 12 and a second fuel cell stack 14. In the present embodiment, the first fuel cell stack 12 is electrically connected in parallel to the second fuel cell stack 14. However, the number of the plurality of fuel cell stacks 12 and 14 is not particularly limited, and may be two or more. In the fuel cell system 10 of the present embodiment, hydrogen gas is used as the fuel gas, and air is used as the oxidizing gas. The air contains oxygen as an oxidizing agent.

As shown in FIG. 1, the fuel cell system 10 further includes a power control unit 18. In the present embodiment, the power control unit 18 includes a step-up converter. The power control unit 18 is electrically connected to each fuel cell stack 12, 14. The power control unit 18 can boost the generated power from the fuel cell stacks 12 and 14 and output the boosted power to the outside. Although not particularly limited, the power control unit 18 may further include an inverter in addition to the step-up converter.

As illustrated in FIG. 1, the fuel cell system 10 further includes an oxidizing gas supply unit 20 and a control device 36. The oxidizing gas supply unit 20 is a unit for supplying oxidizing gas (air) to each of the plurality of fuel cell stacks 12 and 14. The oxidizing gas supply unit 20 includes a compressor 22, an oxidizing gas supply path 24, a plurality of inlet valves 26, an off-gas discharge path 28, a plurality of outlet valves 30, a flow dividing path 32, and a flow dividing valve 34. The control device 36 can start and stop the operation of the fuel cell stacks 12, 14. The control device 36 may control the operation of the compressor 22, the inlet valve 26, the outlet valve 30, and the flow dividing valve 34 to adjust the supply flow rate and the supply pressure of the oxidizing gas supplied to each of the fuel cell stacks 12 and 14.

The compressor 22 is a turbo compressor. The oxidizing gas supply path 24 includes a first oxidizing gas supply path 24a and a second oxidizing gas supply path 24b. The compressor 22 is provided in the first oxidizing gas supply path 24a. The compressor 22 compresses air taken from the outside and supplies the compressed air to the plurality of fuel cell stacks 12 and 14. The first oxidizing gas supply path 24a is connected to the cathode-side supply port 16a of the first fuel cell stack 12. The second oxidizing gas supply path 24b is connected to the cathode-side supply port 16a of the second fuel cell stack 14. The first oxidizing gas supply path 24a is connected to the second oxidizing gas supply path 24b at the branch point B1. A portion of the air compressed by the compressor 22 is supplied to the cathode-side supply port 16a of the first fuel cell stack 12 through the first oxidizing gas supply path 24a. The other portion of the air compressed by the compressor 22 is supplied to the cathode-side supply port 16a of the second fuel cell stack 14 through the second oxidizing gas supply path 24b. An inlet valve 26 is provided between the first oxidizing gas supply path 24a and the cathode-side supply port 16a and between the second oxidizing gas supply path 24b and the cathode-side supply port 16a, respectively. Although not particularly limited, the oxidizing gas supply unit 20 may further include an intercooler that cools the high-temperature air compressed by the compressor 22.

The off-gas discharge path 28 includes a first off-gas discharge path 28a and a second off-gas discharge path 28b. The first off-gas discharge path 28a is connected to the cathode-side discharge port 16b of the first fuel cell stack 12. The second off-gas discharge path 28b is connected to the cathode-side supply port 16a of the second fuel cell stack 14. The first off-gas discharge path 28a is connected to the second off-gas discharge path 28b at the branch point B2. The air that has passed through the fuel cell in the first fuel cell stack 12 is discharged from the first fuel cell stack 12 to the first off-gas discharge path 28a through the cathode-side discharge port 16b. The air that has passed through the fuel cell in the second fuel cell stack 14 is discharged from the second fuel cell stack 14 to the second off-gas discharge path 28b through the cathode-side discharge port 16b, and then sent to the first off-gas discharge path 28a. An outlet valve 30 is provided between the first off-gas discharge path 28a and the cathode-side discharge port 16b, and between the second off-gas discharge path 28b and the cathode-side discharge port 16b.

The flow dividing path 32 connects the oxidizing gas supply path 24 and the off-gas discharge path 28 to each other. In the present embodiment, the flow dividing path 32 connects the first oxidizing gas supply path 24a and the first off-gas discharge path 28a to each other. A flow dividing valve 34 is provided in the flow dividing path 32. In response to the opening and closing of the flow dividing valve 34 and the outlet valve 30, part or all of the air flowing through the first oxidizing gas supply path 24a is not supplied to the fuel cell stacks 12 and 14, but is sent to the first off-gas discharge path 28a through the flow dividing path 32. Accordingly, the control device 36 can adjust the supply flow rate of the oxidizing gas supplied to the fuel cell stacks 12 and 14.

Although not shown, the fuel cell system 10 further includes a fuel gas supply unit. The fuel gas supply unit is a unit for supplying fuel gas (hydrogen gas) to the fuel cell stacks 12 and 14.

As shown in FIG. 1, the fuel cell system 10 further includes a cooling unit 38. The cooling unit 38 is a unit for cooling each of the plurality of fuel cell stacks 12 and 14. The cooling unit 38 includes a radiator 40, a circulation path 42, a pump 44, and a plurality of temperature sensors 46 and 48. The radiator 40 discharges heat from the refrigerant circulating in the circulation path 42. The circulation path 42 includes a forward path 42a for supplying the refrigerant from the radiator 40 to the fuel cell stacks 12 and 14, and a return path 42b for returning the refrigerant from the fuel cell stacks 12 and 14 to the radiator 40. The pump 44 is provided in the forward path 42a.

The plurality of temperature sensors 46, 48 includes a first temperature sensor 46 and a second temperature sensor 48. The first temperature sensor 46 is provided at the outlet of the first fuel cell stack 12 in the return path 42b, and detects the temperature of the coolant that has passed through the first fuel cell stack 12. The second temperature sensor 48 is provided at the outlet of the second fuel cell stack 14 in the return path 42b, and detects the temperature of the coolant that has passed through the second fuel cell stack 14. The refrigerant absorbs heat from the fuel cell when passing through the plurality of fuel cell cells in the fuel cell stacks 12 and 14. Therefore, D1, D2 detected by each temperature sensor 48, that is, the temperature of the coolant at the outlet of each fuel cell stack 12, 14, correlates with the actual temperature of the fuel cell stack 12, 14. Here, the actual temperature of the fuel cell stacks 12 and 14 means the actual temperature of the fuel cell stacks 12 and 14. Hereinafter, the detected value D1 by the first temperature sensor 46 is referred to as a first detected value D1, and the detected value D2 by the second temperature sensor 48 is referred to as a second detected value D2.

The control device 36 determines the target cooling temperature TT of the fuel cell stacks 12, 14 commanded to the cooling unit 38. Then, the control device 36 controls the pump 44 based on D1, D2 detected by the temperature sensors 46 and 48 to adjust the flow rate of the coolant supplied to the fuel cell stacks 12 and 14. As a result, the fuel cell stacks 12 and 14 are cooled so that the temperatures of the fuel cell stacks 12 and 14 become the target cooling temperature TT. In one example, the refrigerant is water. As another embodiment, the control device 36 may directly detect the actual temperature of each of the fuel cell stacks 12 and 14. As yet another embodiment, the control device 36 may estimate the actual temperature of each fuel cell stack 12, 14 based on each detected value D1, D2. In other embodiments, the fuel cell system 10 may include a separate cooling unit 38 for each fuel cell stack 12, 14.

In the fuel cell system 10 described above, the supply pressure and the supply flow rate of the oxidizing gas to be supplied to the fuel cell stacks 12 and 14 are determined in accordance with the requested output (i.e., generated power) and the temperature of the fuel cell stacks 12 and 14. FIG. 2 shows the relationship between the target supply pressure and the target supply flow rate of the oxidizing gas that the control device 36 instructs the oxidizing gas supply unit 20 in accordance with the output required for the fuel cell stacks 12 and 14. Each of the solid lines U1 to U4 indicates a relation between a supply flow rate of the oxidizing gas and a supply pressure of the oxidizing gas for different temperatures of the fuel cell stacks 12 and 14. Each of the dashed lines P1 to P5 indicates the relation between the supply flow rate of the oxidizing gas and the supply pressure of the oxidizing gas for the different currents (i.e., generated electric power) of the fuel cell stacks 12 and 14. The larger the number, the higher the temperature or the higher the power. For example, as shown in FIG. 2, when the temperature of the fuel cell stacks 12 and 14 is constant, the supply pressure and the supply flow rate of the oxidizing gas are increased as the output required for the fuel cell stacks 12 and 14 is increased. Therefore, when the number of operation of the fuel cell stacks 12 and 14 is decreased, the supply pressure and the supply flow rate of the oxidizing gas also increase in the fuel cell stack 12 (or 14) that continues the operation because the requested output increases.

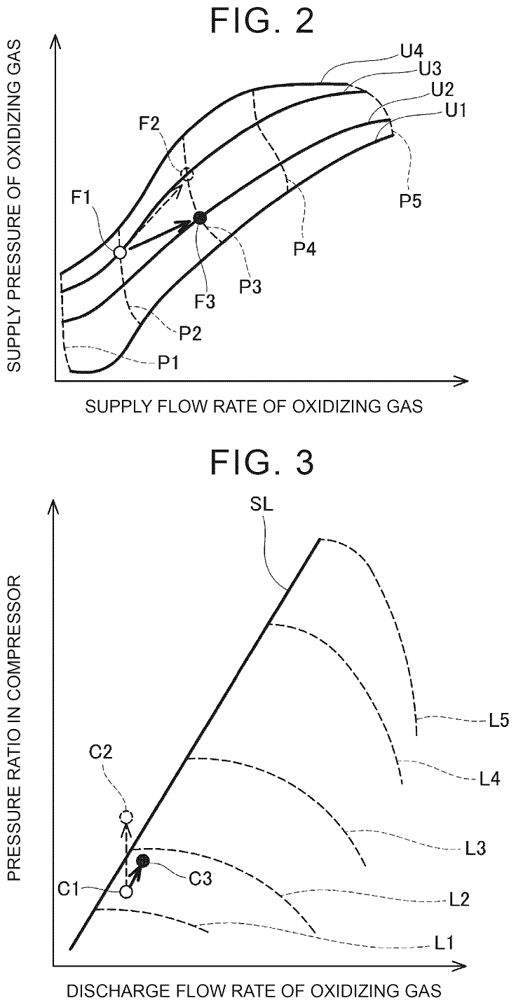

In this regard, in the fuel cell system 10 of the present embodiment, a turbo compressor 22 is employed to supply the oxidizing gas. Therefore, if the pressure ratio in the compressor 22 is increased in order to increase the supply pressure of the oxidizing gas to the fuel cell stacks 12 and 14, surging of the compressor 22 may occur. FIG. 3 shows a surging constraint line SL of the compressor 22. Each of the dotted lines L1 to L5 indicates a relation between the discharge flow rate of the oxidizing gas by the compressor 22 and the pressure-ratio in the compressor 22, with respect to a different rotational speed of the compressor 22. Incidentally, the larger the number, which means that the rotational speed is larger. As illustrated in FIG. 3, in the fuel cell system 10, a surging constraint line SL is defined for an operating point (combined pressure ratio and discharge flow rate) of the compressor 22. For example, when the operating point of the compressor 22 moves from the point C1 to the point C2 and exceeds the surging constraint line SL, surging may occur in the compressor 22. In order to avoid this, in the fuel cell system 10 of the present embodiment, an increase in the supply pressure is suppressed by preferentially increasing the supply flow rate of the oxidizing gas. As a result, an increase in the pressure ratio in the compressor 22 is suppressed. Further, the discharge flow rate of the oxidizing gas by the compressor 22 is also increased, thereby effectively suppressing the generation of surging (point C3 from the point C1 in FIG. 3). However, as the supply pressure of the oxidizing gas supplied to the fuel cell stack is smaller, drying of the electrolytic film is accelerated in the fuel cell stacks 12 and 14, and so-called dry-up may occur. Alternatively, in the fuel cell stacks 12 and 14, drying of the electrolyte membrane is accelerated as the flow rate of the oxidizing gas is increased, and so-called dry-up may occur (point F2 from the point F1 in FIG. 2).

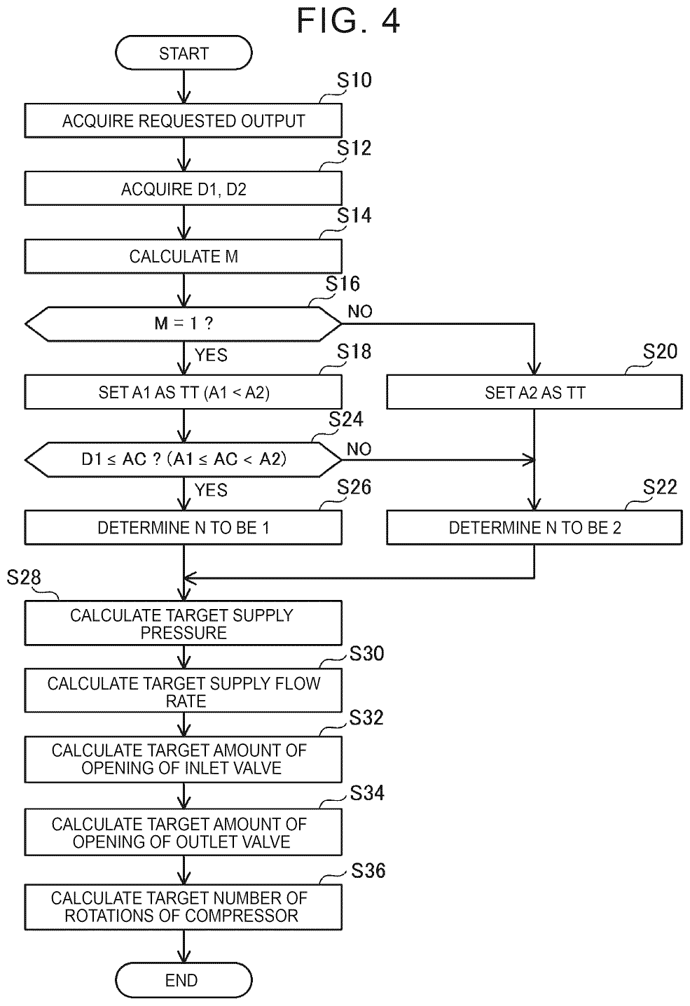

In view of the above, when the temperature of the fuel cell stacks 12 and 14 is lowered, the supply pressure of the oxidizing gas is suppressed, and even when the supply flow rate of the oxidizing gas is increased accordingly, the dry-up of the fuel cell stacks 12 and 14 can be suppressed (F3 from the point F1 in FIG. 2). Based on this finding, the control device 36 of the present embodiment is configured to execute the first process illustrated in FIG. 4. The control device 36 selectively operates one or both of the fuel cell stacks 12 and 14 by repeatedly executing the first process. In the following description, it is assumed that the number of fuel cell stacks 12, 14 that are operated is two at first. By executing the first process, the control device 36 can reduce the temperature of the first fuel cell stack 12 that continues operation when the number of fuel cell stacks 12, 14 that are operated is reduced to 1.

As illustrated in FIG. 4, the control device 36 acquires a requested output from the outside (S10). Then, the control device 36 acquires the first detected value D1 and the second detected value D2 (S12). As described above, the first detected value D1 and the second detected value D2 are correlated with the actual temperatures of the fuel cell stacks 12 and 14, respectively. In the present embodiment, the detected values D1, D2 are used as indices indicating the actual temperatures of the fuel cell stacks 12, 14.

Next, the control device 36 calculates the requested number M of fuel cell stacks to be operated out of the fuel cell stacks 12, 14, based on the requested power acquired by S10 (S14). When the calculated requested number M is 2 (NO in S16), the control device 36 sets the second temperature A2 as the target cooling temperature TT of the fuel cell stacks 12 and 14 instructed to the cooling unit 38 (S20), and determines the actual number N of fuel cell stacks 12, 14 to be operated to be 2 (S22). When the calculated requested number M is 1 (YES in S16), the control device 36 selects one fuel cell stack to continue the operation and decides to shut down the remaining fuel cell stack. In the present embodiment, the first fuel cell stack 12 is selected as the fuel cell stack that continues the operation, and it is determined to stop the operation of the second fuel cell stack 14. However, the method of selecting the fuel cell stack to continue the operation is not particularly limited. As an example, a fuel cell stack that continues operation may be selected based on the operation history of the fuel cell stacks 12 and 14, the actual temperature of the fuel cell stacks 12 and 14, and the like.

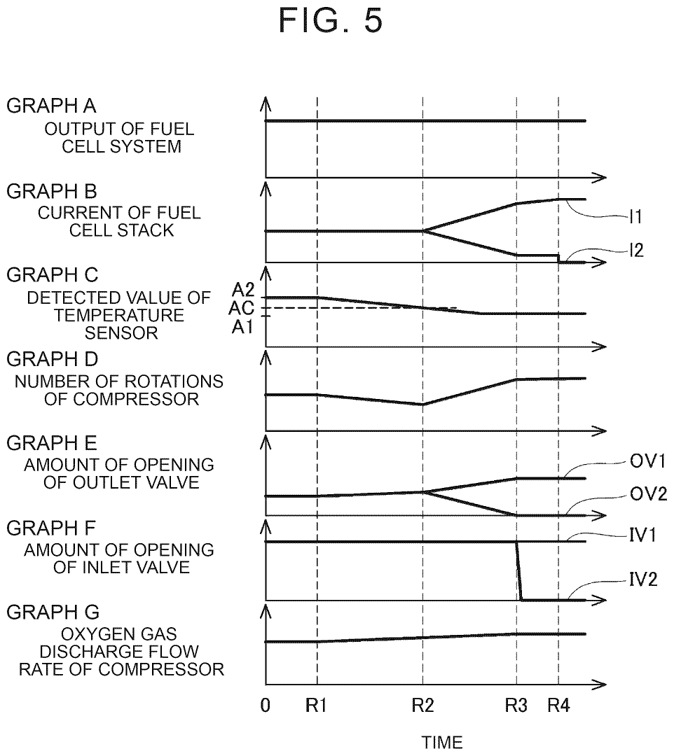

The control device 36 sets the first temperature Al as the target cooling temperature TT of the first fuel cell stack 12 that continues the operation (S18, time R1 in FIG. 5). Here, the first temperature A1 is a temperature lower than the second temperature A2. As described above, since the number of operations for the fuel cell stacks 12 and 14 is two at the starting point of the first process, the second temperature A2 is set as the target cooling temperature TT of the fuel cell stacks 12 and 14. Therefore, by S18 process, the target cooling temperature TT of the operating first fuel cell stack 12 decreases from the second temperature A2 to the first temperature A1. The first temperature A1 and the second temperature A2 may be fixed values or may be variable values that vary based on various parameters.

Then, the control device 36 determines whether the first detected value D1 is equal to or less than the predetermined value AC (S24). Here, the predetermined value AC is a temperature that is equal to or higher than the first temperature A1 and lower than the second temperature A2. The predetermined value AC may be a fixed value or may be a variable value that varies based on various parameters. The graphical A-G of FIG. 5 shows changes over time of various parameters in the first process shown in FIG. 4. In graph B of FIG. 5, the curve I1 indicates the current of the first fuel cell stack 12, and the curve I2 indicates the current of the second fuel cell stack 14. In the graph E of FIG. 5, the curve OV1 indicates the opening degree of the outlet valve 30 of the first fuel cell stack 12, and the curve OV2 indicates the opening degree of the outlet valve 30 of the second fuel cell stack 14. In the graph F of FIG. 5, the curve IV1 indicates the opening degree of the inlet valve 26 of the first fuel cell stack 12, and the curve IV2 indicates the opening degree of the inlet valve 26 of the second fuel cell stack 14. For example, as shown in the graph C of FIG. 5, a time lag may occur after the target cooling temperature TT is lowered to the first temperature A1 until the temperature of the first fuel cell stack 12 is lowered to a predetermined value AC. If NO in S24, the control device 36 determines the actual number N of fuel cell stacks 12, 14 to be operated to 2 (S22). On the other hand, when S24 is YES (time R2 in FIG. 5), the control device 36 determines the actual number N of fuel cell stacks 12, 14 to be operated to be 1 (S26).

Thereafter, the control device 36 calculates the target supply pressure of the oxidizing gas to be instructed to the oxidizing gas supply unit 20 in accordance with the determined actual number N (S28), and calculates the target supply flow rate of the oxidizing gas to be instructed to the oxidizing gas supply unit 20 (S30). The control device 36 of the present embodiment stores in advance a map describing the relationship (see FIG. 2) between the target supply pressure and the target supply flow rate of the oxidizing gas to be instructed to the oxidizing gas supply unit 20. Therefore, the control device 36 calculates the target supply pressure and the target supply flow rate of the oxidizing gas according to the actual number N based on the relationship described by the map stored in advance.

The control device 36 calculates a target opening degree to be instructed to the inlet valve 26 of the oxidizing gas supply unit 20 (S32), and calculates a target opening degree to be instructed to the outlet valve 30 of the oxidizing gas supply unit 20 (S32). Note that the control device 36 may calculate a target opening degree to be instructed to the flow dividing valve 34 in addition to the outlet valve 30 of the oxidizing gas supply unit 20. Next, the control device 36 calculates a target rotational speed to be instructed to the compressor 22 (S36). The control device 36 controls each unit according to the calculated value, and ends one cycle of the first process illustrated in FIG. 4.

In the fuel cell system 10 described above, the temperature of the first fuel cell stack 12 that continues operation can be reduced when the actual number N of fuel cell stacks 12, 14 to be operated is reduced. This makes it possible to avoid dry-up of the fuel cell stack 12 while avoiding surging of the compressor 22.

In the first process described above, after the target cooling temperature TT is lowered according to the reduction in the requested number M, the actual number N of fuel cell stacks 12, 14 to be operated is reduced after the actual temperature (in this case, the first detected value D1) of the fuel cell stacks 12 and 14 is reduced to the predetermined value AC. According to such a configuration, even when a time lag occurs after the target cooling temperature TT is lowered until the actual temperature of the fuel cell stack 12 is lowered to a predetermined value AC, it is also possible to more reliably avoid the dry-up of the fuel cell stack 12. In the first process illustrated in FIG. 4, the control device 36 may omit the process of S24. That is, in other embodiments, the control device 36 may reduce the actual number N of fuel cell stacks 12, 14 to be operated after setting the first temperature Al as the target cooling temperature TT, regardless of the actual temperature of the fuel cell stacks 12, 14.

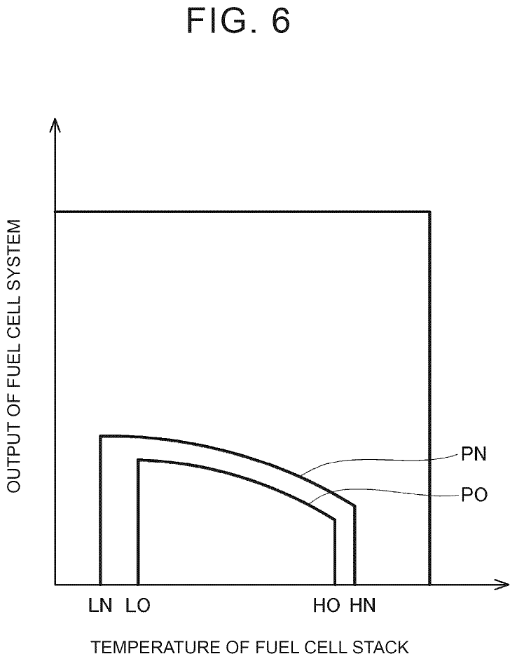

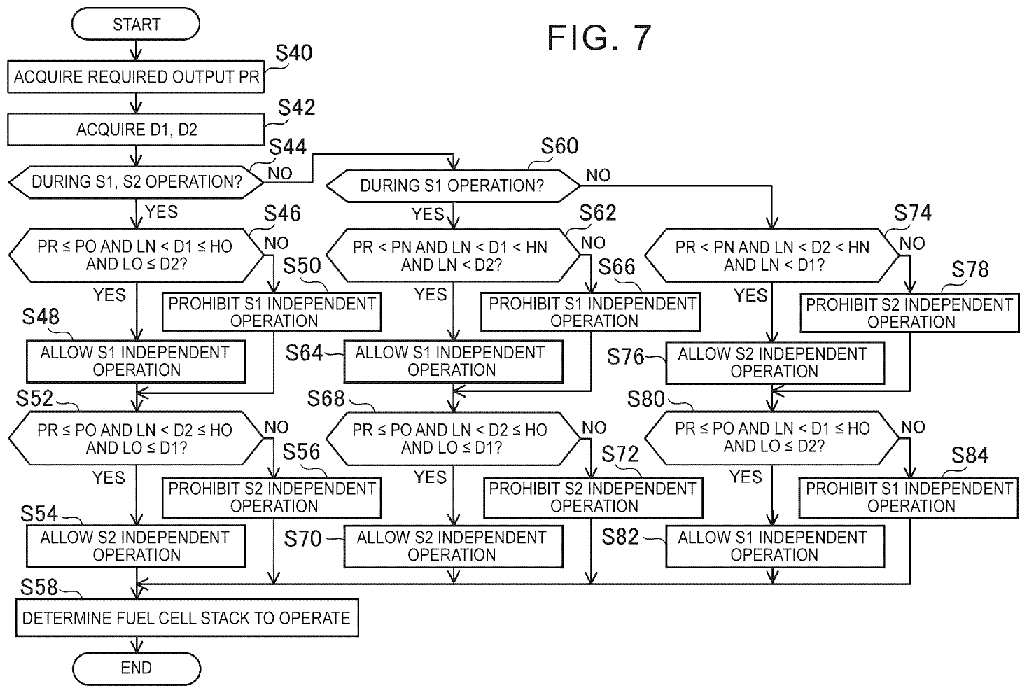

Dry-up of the fuel cell stacks 12 and 14 depends on the temperatures of the fuel cell stacks 12 and 14, and as the temperatures of the fuel cell stacks 12 and 14 are higher, dry-up of the fuel cell stacks 12 and 14 is more likely to occur. Therefore, it is effective to prohibit or limit the decrease in the number of operations of the fuel cell stacks 12 and 14 when the temperature of the fuel cell stacks 12 and 14 is high. Specifically, regardless of the temperature of the fuel cell stacks 12, 14, the number of operations of the fuel cell stacks 12, 14 is reduced when the output required for the entire fuel cell system 10 is below a predetermined reference value. However, as shown in FIG. 6, the reference value (that is, the first upper limit output value PN and the second upper limit output value PO) for the output required for the entire fuel cell system 10 is not constant, but the reference value is set to be lower as the temperature of the fuel cell stacks 12 and 14 is higher. As a result, in the fuel cell stack 12 (or 14) that continues operation, an increase in the requested output is suppressed, and an increase in the required supply pressure and supply flow rate is also suppressed. Based on this finding, the control device 36 of the present embodiment is configured to repeatedly execute the second process illustrated in FIG. 7.

As illustrated in FIG. 7, the control device 36 acquires a requested-output PR from the outside (S40). Then, the control device 36 acquires the first detected value D1 and the second detected value D2 (S42). As described above, since each detected value D1, D2 is correlated with the actual temperature of each fuel cell stack 12, 14, in the present embodiment, each detected value D1, D2 is adopted as an index indicating the actual temperature of each fuel cell stack 12, 14.

The control device 36 determines whether the two fuel cell stacks 12, 14 are both in operation (S44). If S44 is YES, the control device 36 determines whether to permit the single operation of the first fuel cell stack 12 during operation (S46). Specifically, the control device 36 determines whether the requested output PR is equal to or less than the second upper limit output value PO, the first detected value D1 is equal to or less than the first lower limit temperature LN and equal to or less than the second upper limit temperature HO, and the second detected value D2 is equal to or greater than the second lower limit temperature LO. As shown in FIG. 6, the second upper limit output value PO is lower as the temperature of the first fuel cell stack 12 is higher. The second upper limit output value PO is a reference value with respect to a requested output PR used for determining whether or not the single operation of operating only one of the fuel cell stacks 12 and 14 is permitted from when the two fuel cell stacks 12 and 14 are operating.

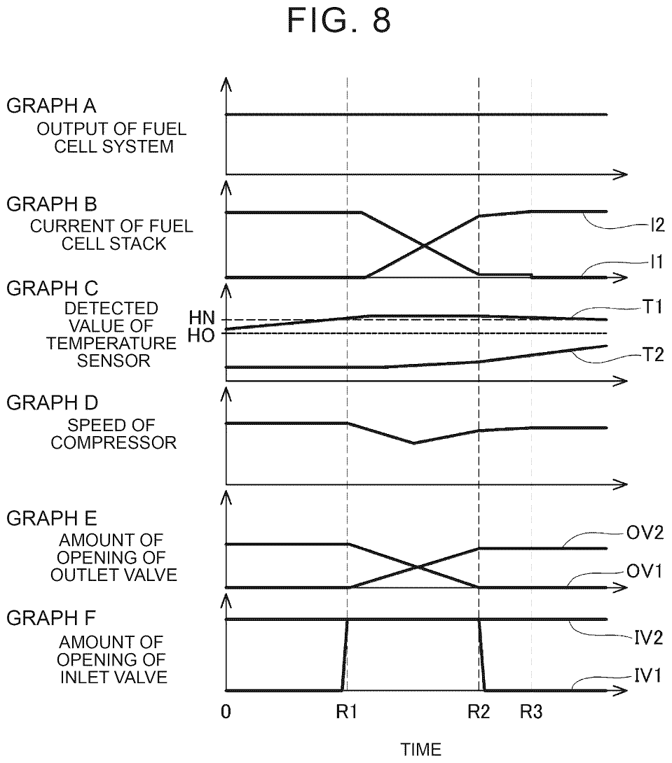

When S44 is YES, the first fuel cell stack 12 is allowed to operate independently (S48). When S44 is NO, the independent operation of the first fuel cell stack 12 is prohibited (S48, time R1 in FIG. 8). The graphical A-G of FIG. 8 shows changes over time of various parameters in the second process shown in FIG. 7. In graph B of FIG. 8, the curve Il indicates the current of the first fuel cell stack 12, and the curve 12 indicates the current of the second fuel cell stack 14. In graph C of FIG. 8, the curve T1 indicates the temperature of the first fuel cell stack 12, and the curve T2 indicates the temperature of the second fuel cell stack 14. In the graph E of FIG. 8, the curve OV1 indicates the opening degree of the outlet valve 30 of the first fuel cell stack 12, and the curve OV2 indicates the opening degree of the outlet valve 30 of the second fuel cell stack 14. In the graph F of FIG. 8, the curve IV1 indicates the opening degree of the inlet valve 26 of the first fuel cell stack 12, and the curve IV2 indicates the opening degree of the inlet valve 26 of the second fuel cell stack 14.

Next, the control device 36 determines whether or not to permit the single operation of the second fuel cell stack 14 during operation (S52). Specifically, the control device 36 determines whether the requested output PR is equal to or less than the second upper limit output value PO, the second detected value D2 is equal to or less than the first lower limit temperature LN and equal to or less than the second upper limit temperature HO, and the first detected value D1 is equal to or greater than the second lower limit temperature LO. If S52 is YES, a standalone operation is permitted for the second fuel cell stack 14 (S54), whereas if NO is S52, a standalone operation is prohibited for the second fuel cell stack 14 (S56).

If S44 is NO, the control device 36 determines whether the first fuel cell stack 12 is in operation (S60). If S60 is YES, the control device 36 determines whether to permit the single operation of the first fuel cell stack 12 during operation (S62). Specifically, the control device 36 determines whether or not the requested output PR is lower than the first upper limit output value PN, the first detected value D1 is higher than the first lower limit temperature LN and lower than the first upper limit temperature HN, and the second detected value D2 is higher than the first lower limit temperature LN. As shown in FIG. 6, the first upper limit output value PN is lower as the first fuel cell stack 12 is higher. The first upper limit output value PN is a reference value for a requested output PR used to determine whether or not the two fuel cell stacks 12 and 14 should be operated in a state in which only one of the fuel cell stacks 12 and 14 is operated (that is, a state in which the fuel cell stack is operated alone).

If S62 is YES, the single operation is permitted for the first fuel cell stack 12 (S64), whereas if NO is S62, the single operation is prohibited for the first fuel cell stack 12 (S66).

Next, the control device 36 determines whether or not the standalone operation is permitted for the second fuel cell stack 14 whose operation is stopped (S68). Specifically, the control device 36 determines whether the requested output PR is equal to or less than the second upper limit output value PO, the second detected value D2 is equal to or less than the first lower limit temperature LN and equal to or less than the second upper limit temperature HO, and the first detected value D1 is equal to or greater than the second lower limit temperature LO. If S68 is YES, a standalone operation is permitted for the second fuel cell stack 14 (S70), whereas if NO is S68, a standalone operation is prohibited for the second fuel cell stack 14 (S72).

If S60 is NO, the control device 36 determines whether the second fuel cell stack 14 in operation is allowed to operate alone (S74). Specifically, the control device 36 determines whether or not the requested output PR is lower than the first upper limit output value PN, the second detected value D2 is higher than the first lower limit temperature LN, lower than the first upper limit temperature HN, and the first detected value D1 is higher than the first lower limit temperature LN. If S74 is YES, a standalone operation is permitted for the second fuel cell stack 14 (S76), whereas if NO is S74, a standalone operation is prohibited for the second fuel cell stack 14 (S78).

Next, the control device 36 determines whether or not the single operation is permitted for the first fuel cell stack 12 whose operation is stopped (S80). Specifically, the control device 36 determines whether the requested output PR is equal to or less than the second upper limit output value PO, the first detected value D1 is equal to or less than the first lower limit temperature LN and equal to or less than the second upper limit temperature HO, and the second detected value D2 is equal to or greater than the second lower limit temperature LO. If S82 is YES, a standalone operation is permitted for the first fuel cell stack 12 (S82), whereas if S80 is NO, a standalone operation is prohibited for the first fuel cell stack 12 (S84).

The control device 36 then determines the fuel cell stacks 12, 14 to be operated (S58). In order to operate the determined fuel cell stacks 12 and 14, the control device 36 controls each unit to end one cycle of the second process illustrated in FIG. 7. In a case where the single operation is permitted for each of the fuel cell stacks 12 and 14, the control device 36 is selected as a fuel cell stack in which one of the first fuel cell stack 12 and the second fuel cell stack 14 is operated. In this case, the method of selecting the fuel cell stack to be operated is not particularly limited. As an example, the fuel cell stacks 12 and 14 that continue to operate may be selected based on the operation history of the fuel cell stacks 12 and 14, the actual temperature of the fuel cell stacks 12 and 14, and the like.

In the above-described fuel cell system 10, when the number of operation of the fuel cell stacks 12 and 14 is reduced, the higher the temperature of the fuel cell stacks 12 and 14, the lower the increase in the output required for the fuel cell stack 12 (or 14) that continues the operation. That is, an increase in the supply pressure and the supply flow rate of the oxidizing gas required for the fuel cell stack 12 (or 14) is also suppressed. This makes it possible to avoid dry-up of the fuel cell stack 12 (or 14) while avoiding surging of the compressor 22.

Note that the first upper limit output value PN and the second upper limit output value PO in this specification are exemplary predetermined reference values with respect to the required power in the present technique. That is, in the present embodiment, two values different from each other are set to give hysteresis to the reference value. However, as another embodiment, one value may be set as the reference value without individually setting the first upper limit output value PN and the second upper limit output value PO. The same applies to the “upper limit temperature” and the “lower limit temperature” described below.

In the present embodiment, in the second process shown in FIG. 7, the actual temperature of the fuel cell stacks 12 and 14 is also taken into consideration when determining whether or not the single operation is permitted for each of the fuel cell stacks 12 and 14. For example, it is determined whether or not the detected-value D1, D2, which is an index indicating the actual temperature of the fuel cell stacks 12 and 14, is lower than the first upper limit temperature HN or lower than or equal to the second upper limit temperature HO. If at least this condition is not satisfied, the single operation of the fuel cell stacks 12 and 14 is prohibited. That is, the control device 36 does not reduce the requested number M of fuel cell stacks to be operated out of the fuel cell stacks 12, 14, regardless of the output required for the fuel cell system 10. According to such a configuration, it is possible to prevent a situation in which the temperature of the fuel cell stack 12 (or 14) is excessively increased. Note that the first upper limit temperature HN and the second upper limit temperature HO in the present specification are upper limit temperatures with respect to the actual temperatures of the fuel cell stacks 12 and 14 in the present technique.

In addition to the above, in the second process illustrated in FIG. 7, it is determined whether or not the detected value D1, D2, which is an index indicating the actual temperature of the fuel cell stacks 12 and 14, exceeds the first lower limit temperature LN or is equal to or higher than the second lower limit temperature LO. If at least this condition is not satisfied, the single operation of the fuel cell stacks 12 and 14 is prohibited. That is, the control device 36 does not reduce the requested number M of fuel cell stacks to be operated out of the fuel cell stacks 12, 14, regardless of the output required for the fuel cell system 10. According to such a configuration, it is possible to prevent a situation in which the temperature of the fuel cell stack 12 (or 14) is excessively lowered. The first lower limit temperature LN and the second lower limit temperature LO in the present specification are lower limit temperatures with respect to the actual temperatures of the fuel cell stacks 12 and 14 in the present technique.

In the second process illustrated in FIG. 7, both the upper limit temperature HN, HO and the lower limit temperature LN, LO do not necessarily have to be set for the detected value D1, D2, which is an index indicating the actual temperature of the fuel cell stacks 12 and 14. In another embodiment, either the upper limit temperature HN, HO or the lower limit temperature LN, LO may be set for the detected-value D1, D2. In still another embodiment, the upper limit temperature HN, HO and the lower limit temperature LN, LO may not be set for the detected-value D1, D2.

### Example 2

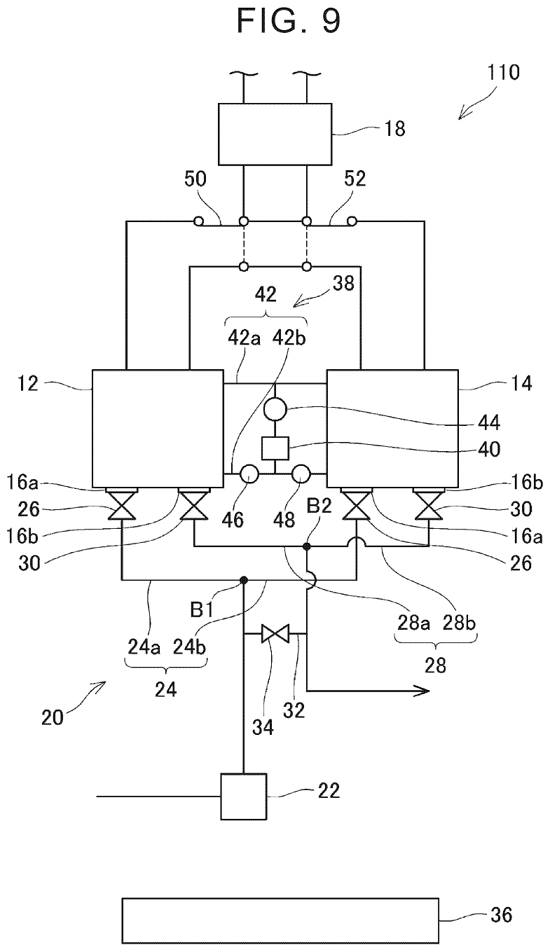

The fuel cell system 110 of the second embodiment will be described with reference to FIG. 9. As shown in FIG. 2, in the fuel cell system 110 of the second embodiment, a plurality of fuel cell stacks 12 and 14 are electrically connected in series as compared with the fuel cell system 10 of the first embodiment. The remainder of the configuration is the same as that of the fuel cell system 10 of the first embodiment, and therefore, a repetitive description thereof will be omitted here.

As illustrated in FIG. 9, the fuel cell system 110 further includes a first relay 50 and a second relay 52. The first relay 50 is provided between one pole of the first fuel cell stack 12 and one pole of the power control unit 18, and the second relay 52 is provided between the other pole of the second fuel cell stack 14 and the other pole of the power control unit 18. As shown in FIG. 9, when the first relay 50 and the second relay 52 are both in the first state, the first fuel cell stack 12 is electrically connected in series with the second fuel cell stack 14. When the first relay 50 is in the first state and the second relay 52 is in the second state (the position indicated by the dotted line), the fuel cell system 10 supplies only the output from the first fuel cell stack 12 to the outside. When the second relay 52 is in the first state and the first relay 50 is in the second state (the position indicated by the dotted line), the fuel cell system 10 supplies only the output from the second fuel cell stack 14 to the outside.

Also in the above configuration, the control device 36 can repeatedly execute the first processing and the second processing in the first embodiment. Accordingly, it is possible to avoid dry-up of the fuel cell stacks 12 and 14 while avoiding surging of the compressor 22.

While several specific examples have been described in detail above, these are merely illustrative and do not limit the scope of the claims. The technique described in 10 the claims includes various modifications and variations of the specific examples exemplified above. The technical elements described in this specification or in the drawings may be used alone or in combination to achieve technical usefulness.

What is claimed is:

1. A fuel cell system comprising:
a plurality of fuel cell stacks;
an oxidizing gas supply unit including a turbo compressor that supplies an oxidizing gas to each of the fuel cell stacks;
a cooling unit that cools each of the fuel cell stacks; and
a control device that determines, according to a requested output, a requested number of fuel cell stacks to be operated out of the fuel cell stacks, a target supply pressure of the oxidizing gas and a target supply flow rate of the oxidizing gas that are to be sent as a command to the oxidizing gas supply unit, and a target cooling temperature of the fuel cell stacks that is to be sent as a command to the cooling unit, wherein the control device reduces the target cooling temperature when reducing the requested number of fuel cell stacks to be operated.

2. The fuel cell system according to claim 1, wherein, after reducing the target cooling temperature according to a reduction in the requested number of fuel cell stacks to be operated, the control device reduces an actual number of fuel cell stacks to be operated after an actual temperature of the fuel cell stacks decreases to a predetermined value.

3. A fuel cell system, comprising:
a plurality of fuel cell stacks;
an oxidizing gas supply unit including a turbo compressor that supplies an oxidizing gas to each of the fuel cell stacks;
a cooling unit that cools each of the fuel cell stacks; and
a control device that determines, according to a requested output, a requested number of fuel cell stacks to be operated out of the fuel cell stacks, a target supply pressure of the oxidizing gas and a target supply flow rate of the oxidizing gas that are to be sent as a command to the oxidizing gas supply unit, and a target cooling temperature of the fuel cell stacks that is to be sent as a command to the cooling unit, wherein the control device decreases the requested number of fuel cell stacks to be operated when the requested output is lower than a predetermined reference value, and sets the reference value to a lower value as an actual temperature of the fuel cell stacks increases.

4. The fuel cell system according to claim 3, wherein, when the actual temperature of the fuel cell stacks is higher than a predetermined upper limit temperature, the control device does not reduce the requested number of fuel cell stacks to be operated, regardless of the requested output.

5. The fuel cell system according to claim 3, wherein, when the actual temperature of the fuel cell stacks is lower than a predetermined lower limit temperature, the control device does not reduce the requested number of fuel cell stacks to be operated, regardless of the requested output.
